(19) United States
(12) Patent Application Publication
(10) Pub. No.: US 2026/0021545 A1
(43) Pub. Date: Jan. 22, 2026

(54) Automatic screwdriving system for fastening components

(71) Applicant: Stöger Automation GmbH, Königsdorf (DE)

(72) Inventor: Lorenz Stöger, Königsdorf (DE)

(21) Appl. No.: 19/263,648

(22) Filed: Jul. 9, 2025

(30) Foreign Application Priority Data
Jul. 9, 2024 (DE) 10 2024 119 447.2

(51) Int. Cl. B23P 19/06; B25J 15/00

(52) U.S. Cl. CPC B23P 19/06; B25J 15/0019

(57) ABSTRACT

A screwdriving system is provided for fastening components that require high contact pressures and includes a screwdriving unit connected to an articulated robot, where the screwdriving unit includes a rotary drive, a torque shaft, a tool holder for a screwdriving tool and a feed head. The tool holder and the feed head are located on a common screw axis, where the screwdriving unit is mounted so as to be pivotable about a ball-like joint arranged in the common screw axis, so that a deflection of a robot axis of the articulated robot caused by high contact pressures and a resulting tilted position of the screwdriving unit is compensated by pivoting of the screwdriving unit, such that the common screw axis maintains a perpendicular position with respect to a plane of the components being fastened.

### PRIORITY CLAIM

The subject application claims convention priority to German patent application No. DE 10 2024 119 447.2, filed Jul. 9, 2024.

### BACKGROUND

The invention relates to an automatic screwdriving system for fastening components that require high contact pressures for their screw fastening. In a system of the kind under consideration, a screwdriving unit is mounted on an articulated robot. The screwdriving unit comprises a motor for the rotary drive, preferably an actuator for the linear drive, a gear mechanism, a torque shaft, a tool holder for a screwdriving tool and a feed head which is automatically supplied with screws, preferably flow-drilling screws, which are held in centering jaws of the feed head during the screwdriving operation. The linear movement of the screwdriving unit can also be generated by the robot. In the case of self-tapping screws, for which there is no drilled hole, the contact pressures of the screwdriving tool are high, being, for example, about 3000 N. The torque shaft, the tool holder, the screwdriving tool and the feed head are located on a common screw axis.

In automatic screwdriving systems of this kind, the high contact pressures exerted on the screws by the screwdriving tool mean that the articulated robot absorbs strong forces which can lead to a deflection of the robot axes, resulting in a deflection and slight tilting of the screwdriving unit. In the case of the screwdriving systems of this kind known hitherto, such a deflection brings about a misalignment of the feed head of the screwdriving unit in which the screw being processed is held, giving rise to strong transverse forces and bending stresses which can result in the screw's being screwed in at a slight angle. During final tightening of the screw it can happen that the screw head does not lie flat against the component and accordingly a small gap is formed. In addition, the torque value of the screw fastening can be distorted, and the screwdriver can be subject to increased wear.

The problem underlying the present invention is to avoid such disadvantages of the automatic screwdriving systems known hitherto and to define an improved system which ensures that, even if the articulated robot is tilted with respect to the plane of the workpiece into which the screws are being screwed and if high contact pressures occur during the screwdriving operation, the screws are screwed in without tilting and without giving rise to a gap between the screw and the workpiece at the end of the screwdriving operation.

### SUMMARY

The invention provides that the screwdriving unit is mounted so as to be pivotable about a ball-like, spherical joint which is arranged in the screw axis, so that a deflection of a robot axis of the articulated robot caused by contact pressures and a resulting tilted position of the screwdriving unit in the X-, Y- or 2-direction can be compensated by pivoting of the screwdriving unit, so that the screw axis maintains its perpendicular position with respect to the plane of the workpieces being fastened. By virtue of such articulated mounting of the screwdriving unit, the feed head lies flat on the workpiece, for example a metal sheet, during the entire screwdriving operation, while the screwdriving unit is pivoted about the ball-like joint located in the screw axis in such a way that the screw axis maintains its perpendicular position with respect to the plane of the workpieces being fastened. This applies to any tilted position of the articulated robot, it being possible for the plane of the components being fastened to be arranged horizontally or at an angle with respect to the horizontal.

The invention further provides that the screwdriving unit is pivotally arranged in a holding device connected to the articulated robot, which holding device has a ball-bearing race, and that the screwdriving unit comprises a spherical segment which rests against the ball-bearing race. The bearing balls of the ball-bearing race are held in a ring shape, preferably in a cage.

Moreover, it is advantageously proposed that the holding device also has spring-loaded bearing balls spaced axially from the ball-bearing race, which bearing balls are each arranged in a ball nest in the holding device and, by means of a spring, protrude a short distance, for example from one to three millimeters, from the ball nest and by so doing are able to engage in recesses in the screwdriving unit and move out of the recesses, as explained in greater detail hereinbelow. For example, three individual bearing balls can be provided which are arranged at a spacing of 120 degrees from one another. In the non-loaded starting state of the screwdriving system the bearing balls accordingly engage in the recesses in the screwdriving unit, so that the position of the screwdriving unit is locked. If high contact pressures occur during the screwdriving operation, the bearing balls release the screwdriving unit.

In more detail it is proposed that the screwdriving unit be provided with a sleeve on which the spherical segment is axially displaceably seated, and that between the sleeve and the spherical segment surrounding it there are arranged compression springs which are held in recesses in the sleeve and engage in indentations in the spherical segment, which indentations face towards the compression springs, it being possible for from three to six compression springs to be arranged uniformly distributed around the circumference.

The compression springs press the sleeve with the recesses against the projecting bearing balls and press the spherical segment against the ball-bearing race. In the non-loaded state of the screwdriving unit (before the start of a screwdriving operation), the screwdriving unit is locked against pivoting about the ball-like joint.

On application of high contact pressures during the screwdriving operation, however, the screwdriving unit performs a stroke against the force of the compression springs such that the bearing balls move out of the recesses, so that the screwdriving unit is able to pivot. The screwdriving unit accordingly maintains its vertical position with respect to the workpiece even if the high contact pressures result in a deflection of robot axes during the screwdriving operation.

It is also advantageously proposed that the spherical segment of the screwdriving unit and the recesses for the bearing balls be arranged on an imaginary sphere and that the screwdriving unit be pivotable or rotatable about the center point of that imaginary sphere.

The center point of the sphere can, in addition, be the center of gravity of the screwdriving unit.

The screwdriving system can optionally comprise a locking cylinder, the piston of which, in the extended position, engages in a bore in the sleeve of the screwdriving unit in order additionally to lock the starting position of the screwdriving unit.

The joining operation, in which the workpiece into which a screw is to be introduced can be firmly clamped, proceeds as follows:
1. the screwdriving unit is positioned with the feed head on the workpiece;
2. the screwdriving tool moves to the screw, which is located in the feed head, and is then subjected to strong axial force;
3. as a result of the strong processing force, the robot axis is deflected through an angle;
4. the deflection of the robot axis is compensated by the ball-like joint in the screw axis;
5. the screwdriving operation is performed, during which no transverse forces act on the screw and the component.

As a result,
a) damage caused by “sliding” of the feed head on the workpiece is avoided;
b) the torque during the screw-fastening operation is not distorted, with the result that process reliability is increased;
c) the screw and the screwdriving tool are subject to less load, with the result that service life is increased;
d) the screw is screwed in straight, with the result that the tightness of the screw fastening is improved.
6. Once the screw has been screwed in, the axial force of the screwdriving tool is withdrawn and the robot returns to its starting position.

### BRIEF DESCRIPTION OF THE DRAWINGS

FIG. 1 is a perspective view of an embodiment of the present automatic screwdriving system;

FIG. 2A is an elevational view of a screwdriving unit of the automatic screwdriving system of FIG. 1, where the screwdriving unit is an initial position;

FIG. 2B is an elevational view of the screwdriving unit showing the screwdriving unit during the screwdriving process without angle compensation;

FIG. 2C is an elevational view of the screwdriving unit showing the screwdriving unit during the screwdriving process with angle compensation;

FIG. 3 is a side view of the screwdriving unit of FIG. 2A;

FIG. 4 is a cross-sectional view of the screwdriving unit of FIG. 3 taken substantially along line 4-4 and in the direction generally indicated and;

FIG. 5 is a cross-sectional view of the screwdriving unit of FIG. 3 taken substantially along line 4-4 and in the direction generally indicated, where the screwdriving unit is in a spherically deflected state.

### DETAILED DESCRIPTION

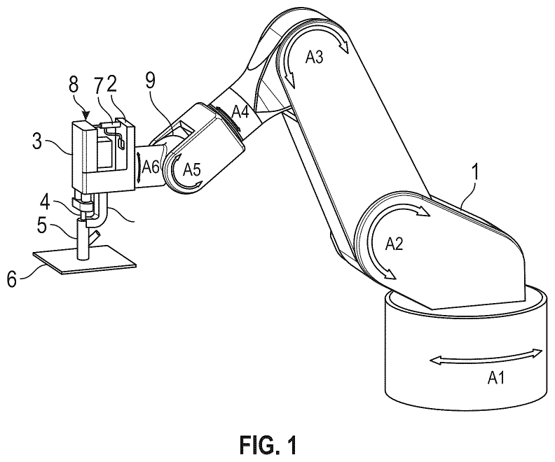

FIG. 1 shows an embodiment of the screwdriving system for fastening components. The screwdriving system comprises an articulated robot 1, the arms A1 to A5 of which are rotatable in the direction of the arrows shown. Mounted on the front robot axis is an adapter 2, to which a screwdriving unit 3 is attached. The screwdriving unit 3 comprises a motor for the rotary drive, a torque shaft, a screwdriving tool 4 and a feed head 5 which is automatically supplied with screws, preferably flow-drilling screws, which are held in centering jaws of the feed head 5 during the screwdriving operation. The torque shaft, the screwdriving tool 4 and the feed head 5 are located on a common screw axis which runs perpendicularly to the plane of the workpiece 6. During the screwdriving operation, the screws are held in the centering jaws of the feed head 5 so that their longitudinal axis coincides with the center longitudinal axis of the feed head 5.

A reset cylinder 7 can be attached to the upper end region of the adapter 2, the piston rod of which reset cylinder is connected to the screwdriving unit 3 located opposite. Such a reset cylinder 7 can be used to lock the non-deflected starting position after completion of a screwdriving operation.

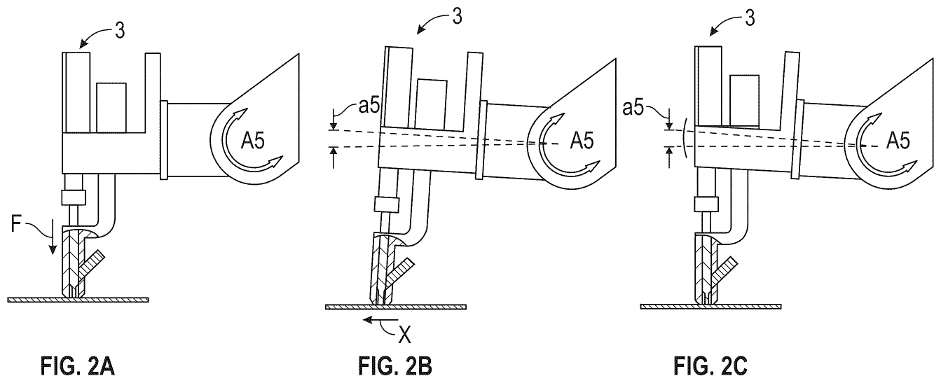

FIG. 2 shows the screwdriving unit 3 attached to the articulated robot in the initial position, the feed head 5 with the centering jaws being shown in section. The screwdriving tool 4 is in engagement with a screw which is held in a vertical position in the centering jaws. During the screwdriving operation a significant contact pressure F is exerted on the screw.

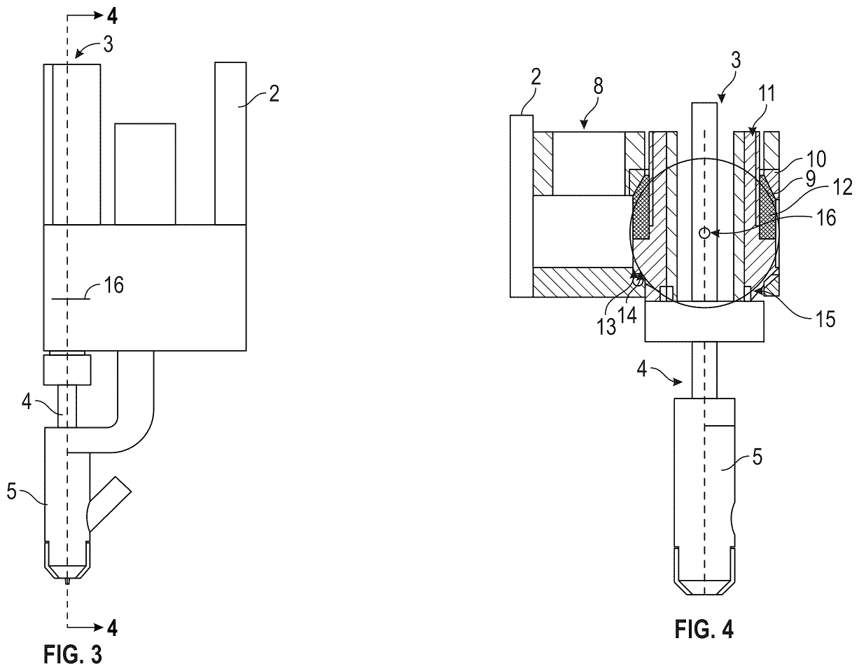

FIG. 3 shows that, as a result of that contact pressure, the screwdriving unit 3 is being pivoted through an angle a 5 in the direction of the arrow, with the result that at the site of the join a force X is being produced which, in the absence of means for angle compensation, would result in a slightly tilted position of the screw during screwing-in.

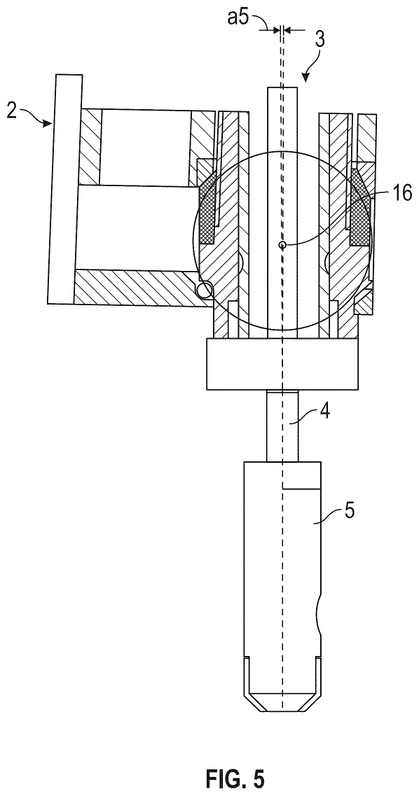

In order that such a faulty screwdriving operation can be avoided, the screwdriving unit 3 is connected to the holding device, which is attached to the articulated robot, by a ball-like joint arranged in the screw axis of the screwdriving unit 3. The screwdriving unit 3, the centering jaws of which in the feed head 5 are pressed firmly against the workpiece 6 and the screw of which is subjected to strong axial force, is pivoted about the joint shown in FIGS. 5 and 6 in such a way that the screw axis maintains its perpendicular position with respect to the plane of the workpiece 6. That angle compensation is shown diagrammatically in FIG. 4.

FIG. 5 shows a sectional view through the screwdriving unit 3 which is able to pivot in a holding device indicated as a whole by reference sign 8, which holding device is attached to the articulated robot 1 with the adapter 2. The holding device 8 comprises a ball-bearing race 9, the annularly arranged bearing balls of which are arranged in a cage attached to the holding device 8. The screwdriving unit 3, which is pivotally mounted in the holding device 8, comprises a spherical segment 10 which rests against the ball-bearing race 9. The spherical segment element 10 is axially displaceably seated on a sleeve 11 of the screwdriving unit 3. Between a radially outer shoulder of the sleeve 11 and the end face of the spherical segment element 10 that faces the shoulder there are arranged compression springs 12 uniformly distributed around the circumference. In the lower end region of the sleeve 11 there are formed recesses in which spring-loaded bearing balls 13 engage, which bearing balls are arranged in the holding device 8 and in the non-loaded state of the screwdriving unit 3 engage in the indentations provided for that purpose, with the result that the non-deflected position of the screwdriving unit 3 is releasably fixed.

The compression springs 12 press the spherical segment element 10 against the ball-bearing race 9 and press the sleeve 11 against the bearing balls 13 that project beyond the holding device 8.

The ball race element 9 and the ball nests 14 with the bearing balls 13 are arranged on an imaginary sphere which is indicated by the circle 15 in the view shown in FIG. 5.

If strong forces act on the screwdriving unit 3 during the screwdriving operation, as indicated in FIG. 3, the screwdriving unit 3 is lifted against the force of the compression springs 12 by a stroke distance that is sufficiently great for the bearing balls 13 to disengage from the sleeve 11, with the result that the screwdriving unit is freely rotatable or pivotable about the center point 16 of the imaginary sphere 15. The stroke of the screwdriving unit 3 is from 1 to 3 mm, preferably 1 mm. The initial position is reached again via the three ball nests against the spring force 12, 13, 14.

FIG. 6 shows a deflected state of the screwdriving unit 3 which has been spherically deflected through an angle α 5.

1. A screwdriving system for fastening components that require high contact pressures for screw fastening, the screwdriving system having a screwdriving unit connected to an articulated robot, the screwdriving system comprising:
a screwdriving unit connected to an articulated robot, wherein the screwdriving unit includes a rotary drive, a torque shaft, a tool holder for a screwdriving tool and a feed head, the tool holder and the feed head being located on a common screw,
wherein the screwdriving unit is mounted so as to be pivotable about a ball-like joint which is arranged in the common screw axis, so that a deflection of a robot axis of the articulated robot caused by contact pressures and a resulting tilted position of the screwdriving unit is compensated by pivoting of the screwdriving unit, so that the screw axis maintains a perpendicular position with respect to a plane of the components being fastened.

2. The screwdriving system according to claim 1, wherein the screwdriving unit is pivotally arranged in a holding device connected to the articulated robot, wherein the holding device has a ball-bearing race; and the screwdriving unit includes a spherical segment element that rests against the ball-bearing race.

3. The screwdriving system according to claim 2, wherein the holding device has individual spring-loaded bearing balls spaced axially from the ball-bearing race, wherein the bearing balls engage in recesses in the screwdriving unit and are configured to move out of the recesses.

4. The screwdriving system according to claim 2, wherein the screwdriving unit includes a sleeve on which the spherical segment element is axially displaceably seated and compression springs are arranged between the sleeve and the spherical segment element surrounding it.

5. The screwdriving system according to claim 4, wherein recesses are formed in the sleeve and the compression springs press the sleeve with the recesses against bearing balls and press the spherical segment element against the ball-bearing race.

6. The screwdriving system according to claim 4, wherein upon application of high contact pressures, the screwdriving unit performs a stroke against a force of the compression springs such that the bearing balls move out of recesses in the screwdriving unit and enable the screwdriving unit to pivot.

7. The screwdriving system according to claim 3, wherein the spherical segment element and the recesses with the bearing balls are arranged on an imaginary sphere; and the screwdriving unit is pivots about a center point of the imaginary sphere.

8. The screwdriving system according to claim 7, wherein center point of the imaginary sphere is the center of gravity of the screwdriving unit.
